(19) United States
(12) Patent Application Publication
(10) Pub. No.: US 2005/0273999 A1
(43) Pub. Date: Dec. 15, 2005

(54) Method and system for fabricating components

(75) Inventors: Juliana Chiang Shei, Niskayuna, NY (US); Judson Sloan Marte, Wynantskill, NY (US); Bin Wei, Mechanicville, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 10/864,677

(22) Filed: Jun. 9, 2004

(51) Int. Cl. B23H 1/00

(52) U.S. Cl. 29/603.16; 156/154; 219/69.17

(57) ABSTRACT

A method for fabricating a component includes providing a workpiece, an electroerosion apparatus comprising an electrode tool. The electroerosion apparatus is operated on the workpiece, for removing a portion thereof. A method for fabricating a composite magnet includes a workpiece comprising a composite material including a magnetizable material and an epoxy resin. An electroerosion apparatus, comprising an electrode tool having an abrasive material, removes a portion of the workpiece by an abrasive action of the electrode tool on the workpiece.

### BACKGROUND OF THE INVENTION

The present invention relates generally to methods and systems for machining composites, and more specifically, to methods and systems for machining composites using electroerosion.

The term “composite material” (also referred to as a “composite”) generally refers to a material made of a mechanical mixture of two or more different materials. In many cases, composites are made of materials having complementary properties, such as where a brittle, high-strength material is encapsulated in a ductile material to give the overall composite sufficient toughness for practical applications. Examples of composite materials include, for example, metal-matrix composites, where a ductile metal is reinforced with a high-strength fiber or particulate phase; concrete, where an aggregate material is bonded together with cement; and fiberglass, where a polymer material is reinforced with glass fibers.

The fabrication of components comprising composites, particularly those composites comprising a significant volume fraction of brittle materials, presents significant technical challenges. The brittle nature of the material presents problems with chipping during machining, for example, often necessitating the use of slow precision processes such as abrasive water-jet cutting and fine diamond grinding to achieve required dimensions and surface finish tolerances.

The problem of slow processing is compounded in applications where the composite component is fabricated by individually machining “blocks” of a first, brittle material to shape, followed by assembly of the blocks into a desired configuration and finally forming a composite component by bonding the blocks together using a second material. This is a common technique used, for example, in the manufacture of large magnets for medical imaging applications. In such a process, a magnetizable material, often a brittle rare earth magnetizable material, is cut by a water-jet cutting apparatus into several specifically shaped blocks that are assembled and bonded together with epoxy to form a magnetizable composite material component. The water-jet process is necessarily slow in order to avoid chipping and cracking the magnetizable material. Further, assembling the blocks requires cumbersome numbering of each block, increasing the chance of error in a final composite shape. It also introduces an irregularity in the final composite shape that is undesirable in composite parts that require a precise shape or have tight tolerances. Certain methods, such as that described in commonly assigned U.S. Pat. No. 6,518,867, allow for the assembly and bonding of the magnetizable material, that is, the formation of the composite, prior to cutting to shape. Although this significantly decreases the processing time, the cutting is still done by a relatively slow process such as water-jet.

Accordingly, it would be advantageous to have faster methods of fabricating components, especially those comprising composite materials that contain brittle materials prone to chipping, to increase productivity and yield of complex products.

### BRIEF DESCRIPTION

The present invention addresses these and other needs by providing a method for fabricating a component including providing at least one workpiece, providing an electroerosion apparatus, and removing a portion of the workpiece by operating the electroerosion apparatus on the workpiece.

An aspect of the invention resides in a method for fabricating a magnet. The method includes providing at least one workpiece that comprises one of Samarium-Cobalt (Sm—Co) and rare earth Iron-Boron (RE-Fe—B) material. The method further comprises providing an electroerosion apparatus, and removing a portion of the workpiece by operating the electroerosion apparatus on the workpiece.

An aspect of the invention resides in a method for fabricating a magnet assembly. The method includes providing at least one workpiece comprising one of Samarium-Cobalt (Sm—Co) and rare earth Iron-Boron (RE-Fe—B) material. An electroerosion apparatus is provided for removing a portion of the at least one workpiece by operating the electroerosion apparatus on the workpiece(s) to form multiple magnet segments. The segments are then assembled to form a magnet assembly.

Another aspect of the invention resides in a method for fabricating a composite magnet, in which a workpiece having a composite material is provided. The composite material includes an epoxy resin and a magnetizable material comprising at least one of Samarium-Cobalt (Sm—Co) and rare earth Iron-Boron (RE-Fe—B) material. An electroerosion apparatus comprising an electrode tool having an abrasive material is provided, and a portion of the workpiece is removed by operating the electroerosion apparatus on the workpiece. At least a portion of the workpiece is removed by an abrasive action of the electrode tool on the workpiece.

### BRIEF DESCRIPTION OF THE DRAWINGS

FIG. 1 is a front view schematic of two states of an electroerosion apparatus.

FIG. 2 is a front view schematic of an electroerosion apparatus.

FIG. 3 is a side view schematic of the electroerosion apparatus of FIG. 2.

FIG. 4 is a perspective view of a composite.

### DETAILED DESCRIPTION

According to a disclosed embodiment, a method for fabricating a component includes providing a (meaning at least one) workpiece. The workpiece may be the component itself or a sub-part thereof. An electroerosion apparatus comprising an electrode tool is provided and operated on the workpiece, removing a portion of the workpiece by operating the electroerosion apparatus on the workpiece.

U.S. patent application Ser. No. 10/248,214 discloses an example of the electroerosion apparatus. In general, electroerosion utilizes a rotating movement of a selectable shape, such as cylindrically shaped, or similar profiled electrode, tapered about the longitudinal axis and having a profiled tip to remove material from a workpiece. The tool-electrode, hereinafter referred to as “electrode tool”, is connected to the negative polarity of a power supply, thereby configuring the electrode tool as a cathode, while the workpiece is connected to the positive polarity, thereby configuring the workpiece as an anode. The workpiece 20 is included in the electroerosion apparatus 10. Briefly, according to the physics of electroerosion process, when the cathode tool approaches the anode workpiece surface to a small proximity gap, for example in a range of approximately 10 microns, an electrical discharge or sparking occurs under a voltage across the gap between the cathode tool and the anode workpiece. The gap, which constitutes a machining zone, is typically filled with a liquid electrolyte medium with moderate to low electrical conductivity, and the gap allows for the flow of electrolyte, which removes eroded particles from the gap besides providing a suitable medium for electrical discharge or sparking for electroerosion.

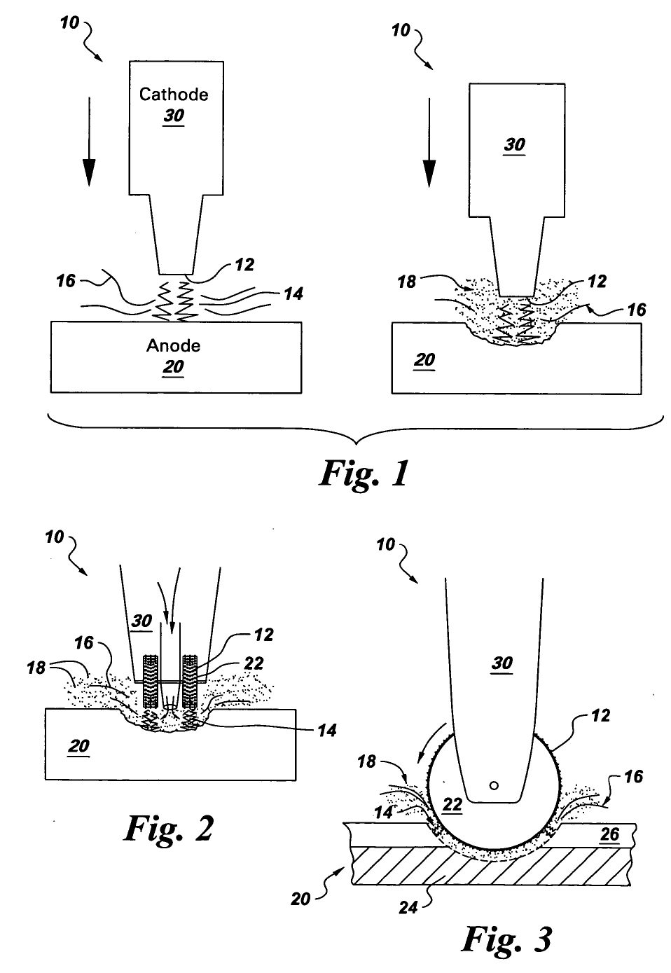

FIG. 1 illustrates, an electroerosion apparatus 10 comprising an electrode tool 30 that is typically configured as a cathode, in accordance with an embodiment. The electrode tool 30 includes a working surface 12 that generates an arc 14 with the anode workpiece 20. The working surface 12 is to be understood as a leading edge of the tool 30, towards the workpiece 20, so as to initiate the arc 14. The term “arc” generally refers to an electric current established between the electrode 30 and the workpiece 20, and such electric current includes an ionization column, a discharge column or a spark between the cathode electrode and the anode workpiece, which are typically suspended in an electrolyte 16, or the electrolyte 16 is provided between the tool 30 and the workpiece 20. The electrolyte 16 may be a suitable chemical solution such as tap water of low electrical conductivity, or an electrolyte such as an aqueous solution of NaNO3, NaNO2, NaCl or the like, which provides a weak conductive medium, and also removes eroded workpiece particles 18. It will be appreciated that many such equivalent electroerosion apparatuses similar to the one as discussed herein may be configured for fabricating components, and are discussed, for example, in the aforementioned application Ser. No. 10/248,214.

FIG. 2 illustrates another embodiment of the electroerosion apparatus 10. The tool 30 comprises at least one tool element 22 having a working surface 12 that is serrated and/or abrasive. The working surface 12 is a leading edge of the tool, which is responsible for machining the workpiece 20 by arcs developed due to the voltage between working surface 12 and workpiece 20, with the electrolyte 16 functional to remove eroded workpiece particles 18. According to an embodiment of the machining method, illustrated by FIG. 3, the tool 30 is configured to remove non-conductive particles in the workpiece by causing an abrasive action of the working surface 12 on the workpiece 20. According to specific embodiments, the tool element 22 is configured to cause an abrasive action of the working surface 12, which is serrated and/or abrasive in nature, on the workpiece 20 for removing the workpiece particles 18 of at least the non-conductive portion 24. More specifically, the working surface 12 is conductive to establish the arc 14, and further, the working surface 12 is serrated and/or abrasive, to remove particles through an abrasive action from the workpiece. The tool 30 and the working surface 12 of the tool element 22 may include at least one of Copper, Iron, Nickel, Molybdenum, Tungsten, and alloys including tool steel or a combination of at least one of the foregoing. As discussed, the tool 30 has a serrated and/or abrasive working surface, and therefore may additionally include abrasive material, for example, a diamond material or ceramic materials such as carbides or nitrides. It is appreciated here that the electroerosion apparatus of FIGS. 1-3 is meant for illustration purposes only, and not intended as a limiting configuration. Other configurations of the apparatus may not be identical to those illustrated in the accompanying figures. For example, one of the embodiments discussed herein illustrates, by way of example, the abrasive action of the tool 30 using a separate tool element 22. However, it is appreciated that other embodiments of the tool are possible, and many such configurations, depending upon the application, will occur to those skilled in the art, and such configurations are included within the scope of disclosed embodiments.

According to an embodiment, a workpiece 20 provided for fabrication includes a magnetizable material. In specific embodiments, the magnetizable material comprises Samarium-Cobalt (Sm—Co), rare earth Iron-Boron (RE-Fe—B) material, or a combination thereof. The electroerosion apparatus 10 having an electrode tool 30 removes at least a portion of the workpiece. As used herein the term “magnetizable material” will be generally understood to include permanent magnet material including rare earth materials, such as Samarium-Cobalt (Sm—Co) and rare earth Iron-Boron (RE-Fe—B) material, for example Neodymium Iron Boron (Nd—Fe—B), and soft magnetizable material, such as ferritic steels, nickel-iron alloys, iron-cobalt alloys, and combinations thereof, for example, Alnico (aluminum, nickel and cobalt alloy), among others. It will be further appreciated that this description is meant to be indicative of the general category of magnetizable materials, and not meant to be restrictive to the specific materials as discussed herein.

According to an embodiment of the fabricating method, providing at least one workpiece comprises providing multiple workpieces. The multiple workpieces are assembled to form a composite material. At least a portion of the composite material is removed by operating the electroerosion apparatus on the composite material. In specific embodiments, the assembling of multiple workpieces comprises bonding the multiple workpieces using a bonding material. The bonding material may comprise a synthetic resin and a silicone, and according to an embodiment the synthetic resin comprises an epoxy. In certain embodiments, the multiple workpieces comprise a magnetizable material, which may comprise a rare earth element for example, neodymium, samarium, among others. In specific embodiments, the magnetizable material comprises one of Samarium-Cobalt (Sm—Co) and rare earth Iron-Boron (RE-Fe—B) material.

According to another embodiment, the workpiece is a composite material. In specific embodiments, the composite material include electrically non-conductive materials, such as, for example, a silicone; a synthetic resin, for example an epoxy resin; a ceramic, for example one of oxides, borides, suicides, aluminides, hydrides, carbides, nitrides, ferrites, carbo-oxy-nitrides, boro-silicides, boro-carbides or combinations thereof; and a fiberglass, or combinations thereof.

In general, conductive materials will be understood to have electrical conductivity generally above about 0.01 Siemens/cm, and the materials with a much lower conductivity, such as that below about 0.0001 Siemens/cm, will be generally understood as non-conductive materials. In general, fabricating non-conductive materials using electroerosion presents challenges because sustenance of an arc is extremely difficult for non-conductive materials. Typically, instance of such non-conductive materials may extinguish the arc established between the workpiece and the tool, and hence, may involuntarily terminate the electroerosion process. As is appreciated, certain embodiments disclosed herein overcome the challenge of removing non-conductive material by using an abrasive action of the tool 30 having a serrated and/or abrasive working surface 12 to remove a non-conductive portion of the workpiece 20.

According to other specific embodiments, the composite material comprises intermetallic materials, such as titanium-aluminide and molybdenum-disilicide, among others. Intermetallic materials are different from metal alloys, in that the constituents of intermetallic materials are chemically associated, whereas in alloys the constituent elements are substantially physically mixed. In another embodiment, the composite material comprises a metal, and/or a metal alloys. Examples of metals include, without limitation, nickel, iron, copper, aluminum, cobalt, niobium, tantalum, molybdenum, chromium, zinc, tin, zirconium, titanium, and alloys comprising any of the foregoing. According to another embodiment, the composite material comprises printed circuit boards. Printed circuit boards have a non-conductive substrate layer over which conductive circuits, typically made of metal, are formed. Electronic components such as circuit chips may be mounted on the printed circuit board and conductively associated with the printed circuit board by metal contacts such as solder joints.

According to a specific example embodying one of the methods disclosed herein, a magnet is fabricated by providing a workpiece including one of Samarium-Cobalt (Sm—Co) and rare earth Iron-Boron (RE-Fe—B) material, or a combination thereof. The electroerosion apparatus 10 operates upon the workpiece 20, and removes at least a portion of the workpiece. The fabricated magnets so obtained, may be used for providing magnet components for medical imaging equipments, among other applications.

According to another embodiment, a magnet assembly is fabricated by providing one or multiple workpieces comprising at least one of Samarium-Cobalt (Sm—Co) and rare earth Iron-Boron (RE-Fe—B) material, and an electroerosion apparatus. The electroerosion apparatus 10 operates upon the workpiece(s), removing at least a portion of the workpiece(s), forming a number of magnet segments. The magnet segments are then assembled to form a magnet assembly.

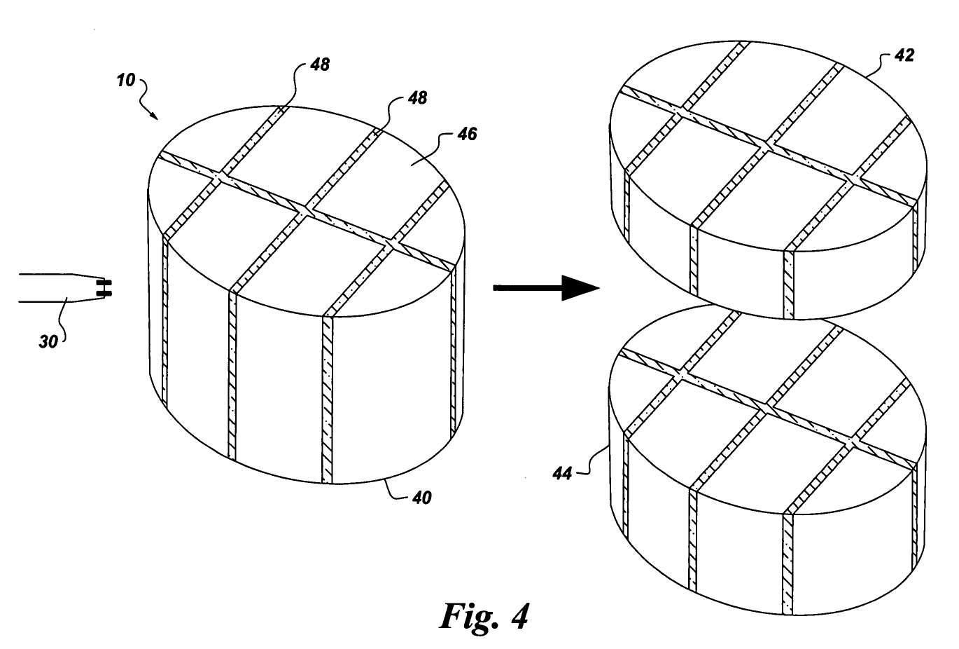

According to an example for fabricating a composite magnet, a workpiece comprising a composite material is provided. Referring to FIG. 4, the composite material includes magnetizable material 46 having at least one of Samarium-Cobalt (Sm—Co) and rare earth Iron-Boron (RE-Fe—B) material, and a synthetic resin 48, for example, an epoxy resin, which are assembled to form a composite magnet, which is a composite magnetizable material workpiece 40. The electroerosion apparatus 10 having an electrode tool 30 then operates upon the composite material workpiece, removing at least a portion of the workpiece by an abrasive action of the electrode tool upon the composite magnetizable material workpiece. The electrode tool may include an abrasive material, for example a diamond material or a ceramic material, for providing the abrasive action. According to other examples, the abrasive action is provided by the electrode tool having serrated work surface configured on the electrode tool, from at least one of Copper, Iron, Nickel, Molybdenum, Tungsten, and alloys comprising at least one of the foregoing. Upon the machining action of the electroerosion apparatus 10 on the composite magnetizable material workpiece 40, at least two parts 42, 44 of machined composite magnets are obtained. The methods as discussed above advantageously eliminate the need to pre-plan cutting of magnetizable materials. Errors that occur while by gluing the machined workpieces for assembling purposes, are also eliminated.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A method for fabricating a component, the method comprising:
providing at least one workpiece;
providing an electroerosion apparatus comprising an electrode tool; and
removing at least a portion of the at least one workpiece by operating the electroerosion apparatus on the at least one workpiece.

2. The method of claim 1, wherein the workpiece comprises a magnetizable material.

3. The method of claim 2, wherein the magnetizable material comprises at least one of Samarium-Cobalt (Sm—Co) and rare earth Iron-Boron (RE-Fe—B) material.

4. The method of claim 1, wherein providing at least one workpiece comprises:
providing a plurality of workpieces; and
assembling the plurality of workpieces to form a composite material,
and wherein removing at least a portion of the at least one workpiece comprises removing at least a portion of the composite material by operating the electroerosion apparatus on the composite material.

5. The method of claim 4, wherein the assembling comprises bonding the workpieces together using a bonding material.

6. The method of claim 5, wherein the bonding material comprises at least one of a synthetic resin and a silicone.

7. The method of claim 6, wherein the synthetic resin comprises an epoxy.

8. The method of claim 5, wherein the workpieces comprise a magnetizable material.

9. The method of claim 8, wherein the magnetizable material comprises a rare earth element.

10. The method of claim 9, wherein the rare earth element is at least one of Neodymium (Nd) and Samarium (Sm).

11. The method of claim 10, wherein the magnetizable material comprises at least one of Samarium-Cobalt (Sm—Co) and rare earth Iron-Boron (RE-Fe—B) material.

12. The method of 1, wherein the workpiece comprises a composite material.

13. The method of claim 12, wherein the composite material comprises an electrically non-conductive material.

14. The method of claim 13, wherein the non-conductive material comprises at least one of, a silicone, a synthetic resin, a ceramic, a fiberglass and a combination comprising at least one of the foregoing.

15. The method of claim 14, wherein the synthetic resin comprises an epoxy resin.

16. The method of claim 14, wherein the ceramic material comprises at least one of oxides, borides, silicides, aluminides, carbides, hydrides, nitrides, ferrites and a combination comprising at least one of the foregoing.

17. The method of claim 12, wherein the composite material comprises at least one intermetallic material.

18. The method of claim 17, wherein the intermetallic material comprises at least one of titanium-aluminide and molybdenum-disilicide.

19. The method of claim 12, wherein the workpiece comprises a printed circuit board.

20. The method of claim 12, wherein the composite material comprises at least one metal.

21. The method of claim 20, wherein the at least one metal comprises Nickel, Iron, Copper, Aluminum, Cobalt, Niobium, Tantalum, Molybdenum, Chromium, Zinc, Tin, Zirconium, Titanium and alloys comprising any of the foregoing.

22. The method of claim 12, wherein the electrode tool comprises at least one of Copper, Iron, Nickel, Molybdenum, Tungsten, tool steel and alloys comprising at least one of the foregoing.

23. The method of claim 13, wherein removing comprises removing at least a portion of the composite material by an abrasive action of the electrode tool upon the workpiece.

24. The method of claim 23, wherein the electrode tool comprises an abrasive material.

25. The method of claim 24, wherein the abrasive material comprises at least one of a diamond and a ceramic material.

26. The method of claim 23, wherein the tool comprises a serrated working surface.

27. The method of claim 13, wherein the electrode tool further comprises at least one tool element comprising at least one of a serrated and an abrasive surface, the tool element configured to remove at least a portion of the composite material by an abrasive action of the tool element upon the workpiece.

28. A method for fabricating a magnet, the method comprising:
providing at least one workpiece, wherein the workpiece comprises at least one of Samarium-Cobalt (Sm—Co) and rare earth Iron-Boron (RE-Fe—B) material;
providing an electroerosion apparatus; and
removing at least a portion of the workpiece by operating the electroerosion apparatus on the workpiece.

29. A method for fabricating a magnet assembly, the method comprising:
providing at least one workpiece, wherein the at least one workpiece comprises at least one of Samarium-Cobalt (Sm—Co) and rare earth Iron-Boron (RE-Fe—B) material;
providing an electroerosion apparatus;
removing at least a portion of the at least one workpiece by operating the electroerosion apparatus on the at least one workpiece to form a plurality of magnet segments; and
assembling the plurality of magnet segments to form a magnet assembly.

30. A method for fabricating a composite magnet, the method comprising:
providing at least one workpiece comprising a composite material, wherein the composite material comprises
a magnetizable material comprising at least one of Samarium-Cobalt (Sm—Co) and rare earth Iron-Boron (RE-Fe—B) material, and
an epoxy resin;
providing an electroerosion apparatus comprising an electrode tool, wherein the electrode tool comprises an abrasive material; and
removing at least a portion of the workpiece by operating the electroerosion apparatus on the workpiece, wherein the removing at least a portion of the workpiece comprises removing at least a portion of the composite material by an abrasive action of the electrode tool upon the workpiece.
